(19) United States
(12) Patent Application Publication
(10) Pub. No.: US 2008/0264573 A1
(43) Pub. Date: Oct. 30, 2008

(54) Door assembly with retractable screen

(75) Inventors: Richard L. Beck, Strasburg, OH (US); Ryan M. Straits, Sugarcreek, OH (US)

Correspondence Address: SAND & SEBOLT, AEGIS TOWER, SUITE 1100, 4940 MUNSON STREET, NW, CANTON, OH, 44718-3615, US

(73) Assignee: Precision Entry, Inc., Sugarcreek, OH (US)

(21) Appl. No.: 11/796,420

(22) Filed: Apr. 27, 2007

(51) Int. Cl. E06B 3/80

(52) U.S. Cl. 160/95

(57) ABSTRACT

A door assembly includes a door body; a panel, typically a window, which is slidably mounted on the door body; a retractable screen mounted on the door; and a removable connection between the screen and the panel. Preferably, the connection is a peelably removable connection. The connection may include a self-mating reclosable fastener, a hook and loop fastener or the like. The connection may include one or more magnets, preferably in the form of flexible magnetic strips. The door assembly thus simplifies the installation of the screen and its removal and replacement.

### BACKGROUND OF THE INVENTION

1. Technical Field

The present invention relates generally to hinged doors having a retractable screen mounted thereon. More particularly, the invention relates to such a door which has a slidable panel or window thereon to which the retractable screen is attached to cover the opening formed when the panel or window moves to an open position. Specifically, the present invention relates to such a door in which the screen is connected to the panel or window so that the screen is easily attachable and removable from the panel or window to facilitate installation and removal and replacement of the screen.

2. Background Information

Doors having a retractable screen mounted thereon and connected to a sliding window of the door are known in the art. For example, see U.S. Pat. No. 6,618,998 granted to Thomas et. al. One of the difficulties in the art relates to the ability to easily attach and remove the screen from the panel or window of the door. The present invention primarily addresses this problem.

### BRIEF SUMMARY OF THE INVENTION

A door assembly comprising a door body; a panel slidably mounted on the door body; a retractable screen mounted on the door body; and a peelably removable connection between the screen and the panel.

A door assembly comprising a door body; a panel mounted on the door body and slidable relative thereto in a first direction; a retractable screen mounted on the door body; and a connection between the screen and panel comprising first and second connecting members removable from one another by a force parallel to the first direction.

A door assembly comprising a generally flat door body which lies generally along a plane; a panel slidably mounted on the door body; a retractable screen mounted on the door body; and a connection between the screen and panel comprising first and second connecting members removable from one another by a force perpendicular to the plane.

### BRIEF DESCRIPTION OF THE SEVERAL VIEWS OF THE DRAWINGS

FIG. 1 is a front elevational view of the door of the present invention.

FIG. 2 is a sectional view taken on line 2-2 of FIG. 1.

FIG. 3 is an enlarged sectional view of the encircled portion of FIG. 2 showing a first embodiment of the connecting mechanism.

FIG. 3A is a sectional view similar to FIG. 3 showing a second embodiment of the connecting mechanism.

FIG. 4 is a front elevational view of the door showing the window being opened and the screen being deployed.

FIG. 5 is a sectional view taken on line 5-5 of FIG. 4.

FIG. 6 is a fragmentary front elevational view showing the upper portion of the door and shows the screen being removed from the window via the first embodiment of the connecting mechanism.

FIG. 7 is similar to FIG. 6 and shows the screen being removed from the window via the second embodiment of the connecting mechanism.

FIG. 8 is a sectional view taken on line 8-8 of FIG. 6 showing the screen removed from the window and the access cover being removed.

FIG. 9 is a sectional view similar to FIG. 8 representing both the removal of the screen assembly and replacement thereof.

Similar numbers refer to similar parts throughout the drawings.

### DETAILED DESCRIPTION OF THE INVENTION

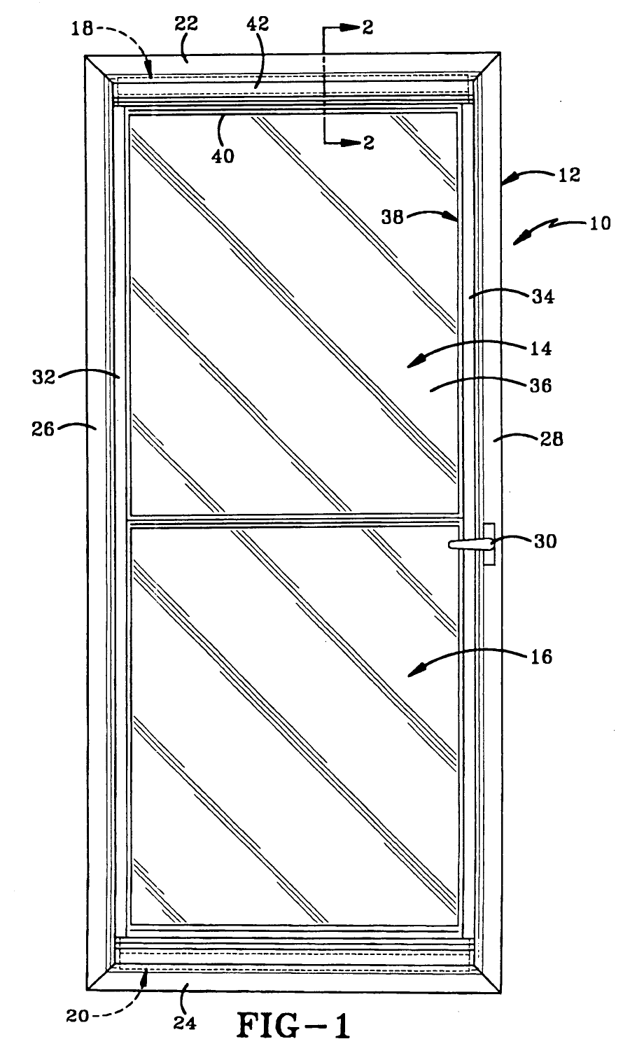

The door of the present invention is indicated generally at 10 in FIG. 1. Door 10 includes a door body 12, upper and lower panels or windows 14 and 16 slidably mounted thereon, and upper and lower retractable screen assemblies 18 and 20. Door body 12 and windows 14 and 16 lie generally along a vertical plane. Door 10 is configured so that when one of the windows is open, the screen of the respective screen assembly moves therewith to cover the resulting opening and retracts as the window is closed.

With continued reference to FIG. 1, door body 12 includes a horizontal upper section 22, a horizontal lower section 24, and first and second vertical side sections 26 and 28 extending between upper and lower sections 22 and 24. Door 10 includes a handle 30 mounted on side section 28 for opening and closing door 10 pivotally on hinges (not shown) along first side section 26. Side section 26 includes a first channel section 32 comprising front and rear vertical side-by-side channels. Likewise, side section 28 includes a second channel section 34 comprising front and rear side-by-side channels which are aligned with and face the respective front and rear channels of channel section 32. Upper window 14 is slidably mounted in the rear channels of sections 32 and 34 while window 16 is slidably mounted within the front channels thereof. Screen assemblies 18 and 20 are mounted respectively on upper and lower sections 22 and 24 and housed therein in a manner that they are generally externally not visible. Assemblies 18 and 20 are substantially identical except that they are mounted in positions which are inverted relative to one another. Thus, only upper assembly 18 will be described. Each of windows 14 and 16 includes a window pane and a sash circumscribing the respective window pane. The sashes of the two windows overlap and abut one another along the central portion of the door in a manner to generally prevent air, water, dust and the like from passing through door 10 when the windows are closed. More particularly, window 14 includes a window pane 36 and a sash 38 including a horizontally extending upper section 40.

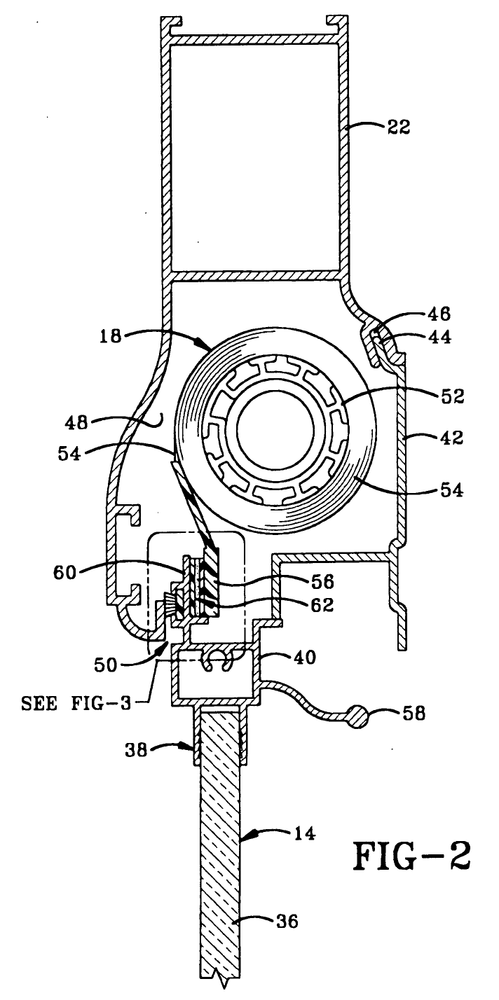

Referring to FIG. 2, an access cover 42 extends from side section 26 to side section 28 and is connected to upper section 22 of door body 12 via a horizontally elongated tongue 44 which is disposed within a horizontally elongated groove 46 of upper section 22. Cover 42 is thus generally pivotally mounted on section 22 via the tongue in the groove connection therebetween. Cover 42 and upper section 22 together form an interior chamber 48 in which screen assembly 18 is rotatably mounted. An entrance opening 50 is in communication with interior chamber 48 and opens downwardly therefrom. Screen assembly 18 comprises a roller 52 which is rotatably mounted on upper section 22 and on which a screen 54 is windingly mounted to allow for extension and retraction thereof. Assembly 18 includes a spring loaded retraction mechanism operatively connected to roller 52 for automatically retracting screen 54 when window 14 moves toward the closed position and which maintains screen 54 under tension during extension and retraction thereof. A reinforced mounting edge 56 is connected to screen 54 so that screen 54 and edge 56 are movable through entrance opening 50 during extension and retraction of screen 54. Upper section 40 of sash 38 includes an outwardly extending handle 40 to facilitate the raising and lowering of window 14 and screen 54 therewith. Upper section 40 further includes a vertically extending mounting arm 60 which is removably connected to mounting edge 56 of screen 54 via a mounting mechanism 62.

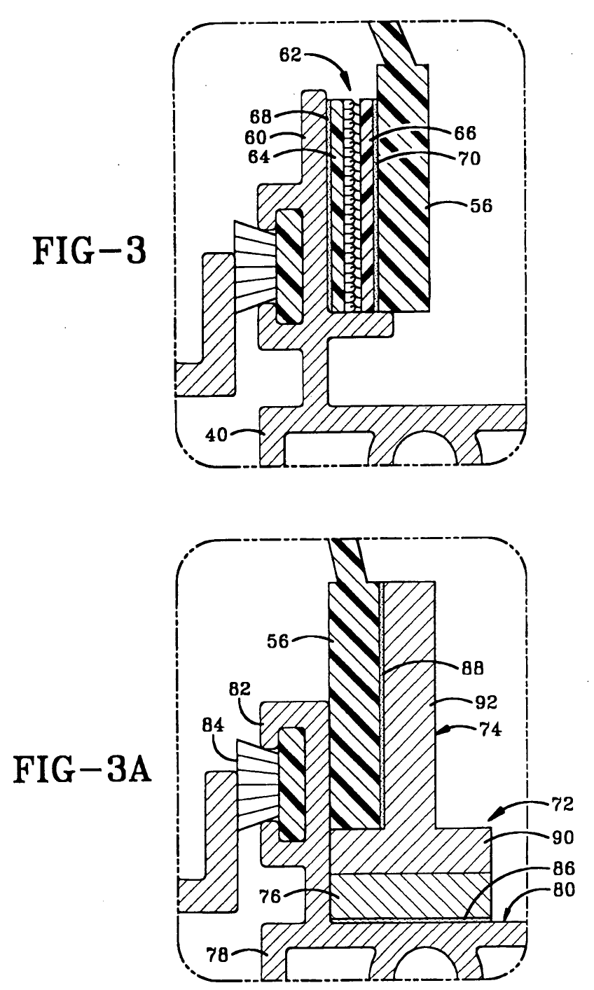

Referring to FIG. 3 and in accordance with a feature of the invention, mounting mechanism 62 is a first embodiment for easy installation and removal of screen 54 from window 14 which facilitates easy installation and removal of assembly 52 from upper section 40. Mounting mechanism 62 includes first and second connecting members 64 and 66 which are peelably removable from one another. Connecting member 64 is attached to mounting arm 60 by an adhesive layer 68. Connecting member 66 is likewise connected to mounting edge 56 by an adhesive layer 70. First and second members 64 and 66 may be, for example, may include the hook portion and loop portion of a hook and loop fastener or the self-mating portions of a self-mating reclosable fastener sold by the Minnesota Mining and Manufacturing Company (3M) under the trademark name Dual Lock. These self-mating reclosable fasteners are described in greater detail in U.S. Pat. No. 6,367,128 granted to Galkiewicz et. al, which is incorporated herein by reference. As shown in FIG. 3, the connection interface between connecting members 64 and 66 is substantially vertical.

Referring to FIG. 3A, an alternate second embodiment of the mounting mechanism 72 is described. Mounting mechanism 72 comprises first and second connecting members 74 and 76, at least one of which comprises a magnet while the other either comprises a magnet or a magnetically attractable material. Most preferably, each of connecting members 74 and 76 comprises a flexible magnetic strip which is elongated horizontally in the connected position shown in FIG. 3A. Mounting mechanism 72 is shown in use with a slightly altered upper section 78 of a window sash similar to sash 38. More particularly, upper section 78 includes a horizontal leg having a horizontal upper surface 80 and a vertically extending arm 82 projecting upwardly therefrom with a brush member 84 mounted thereon similar to that shown in FIG. 3. Connecting member 76 is attached to upper surface 80 via an adhesive layer 86 and connecting member 74 is likewise connected to mounting edge 56 via another adhesive layer 88. More particularly, the magnetic strip has a T-shaped cross section which is in an inverted position such that member 74 includes a horizontal cross bar 90 and a vertically extending upright 92 projecting upwardly therefrom. Cross bar 90 is thus magnetically connected to connecting member 76 along a substantially horizontal connection interface therebetween. Upright 92 is connected to mounting edge 56 via adhesive layer 88 along a substantially vertical interface therebetween so that mounting edge 56 is disposed between upright 92 and arm 82 of upper section 78 with mounting edge 56 abutting arm 82.

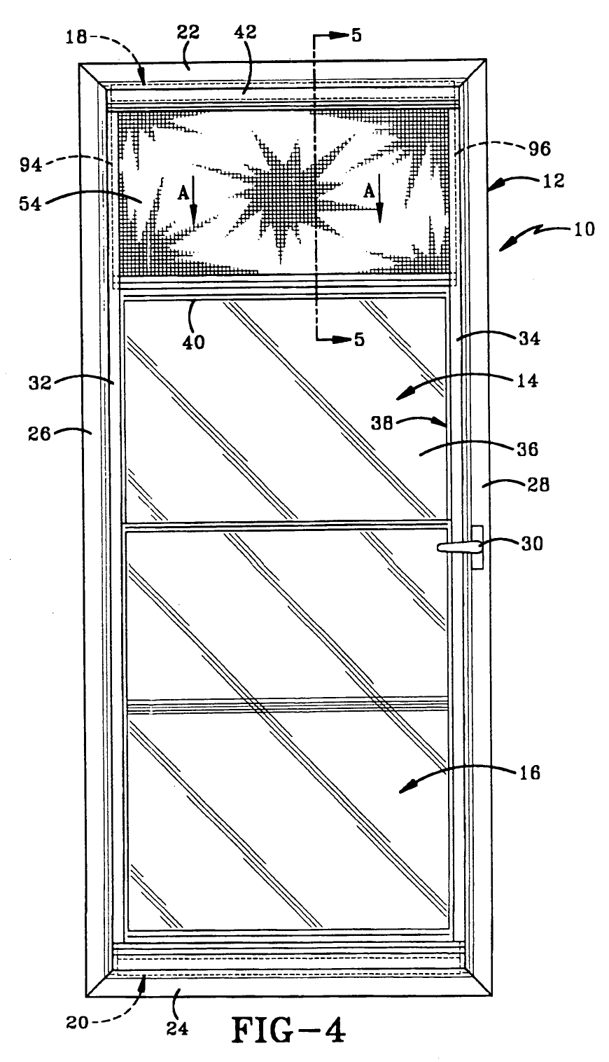

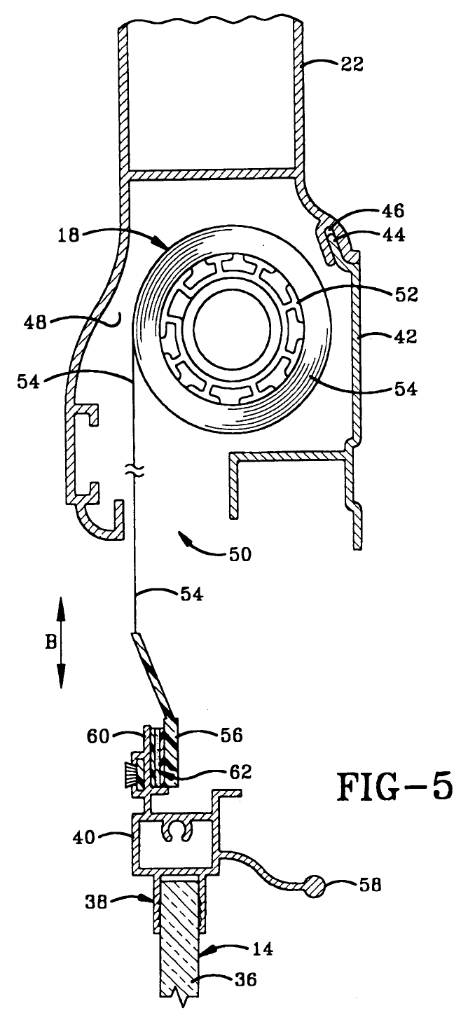

The general operation of door 10 is shown in FIGS. 4 and 5, with FIG. 4 showing window 14 being lowered with screen 54 being lowered therewith as indicated at arrows A during extension of screen 54 as it unwinds from roller 52. As shown in. FIG. 4, screen 54 has first and second opposed lateral edges 94 and 96 which are respectively disposed within the rear channels of first and second channel sections 32 and 34 when screen 54 is extended. FIG. 5 illustrates the extension and retraction of screen 54 at arrow B as screen 54 passes through entrance opening 50.

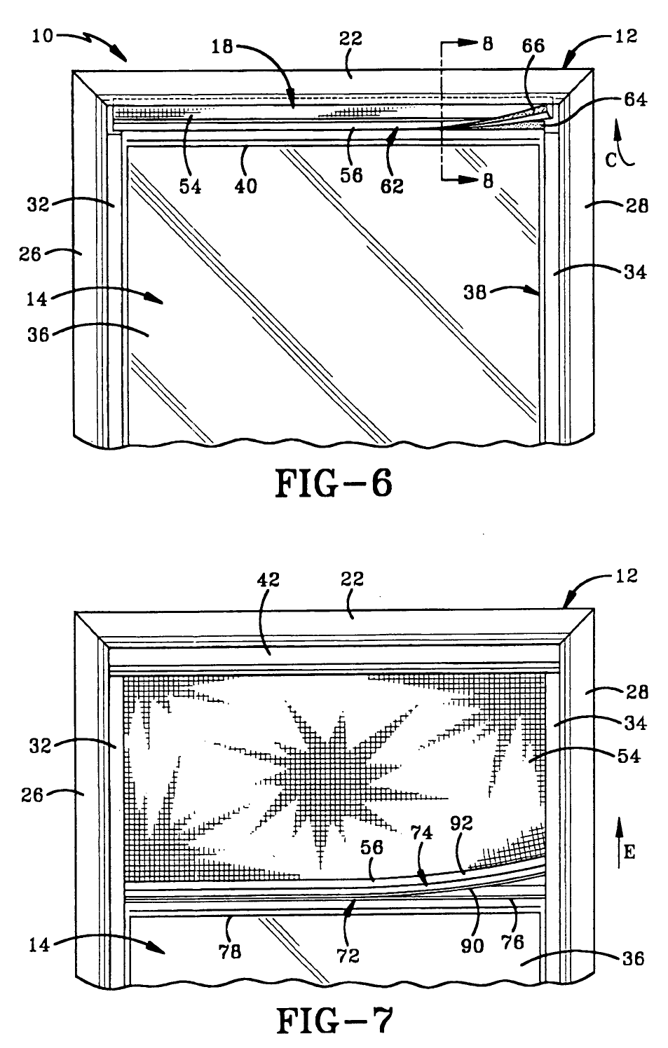

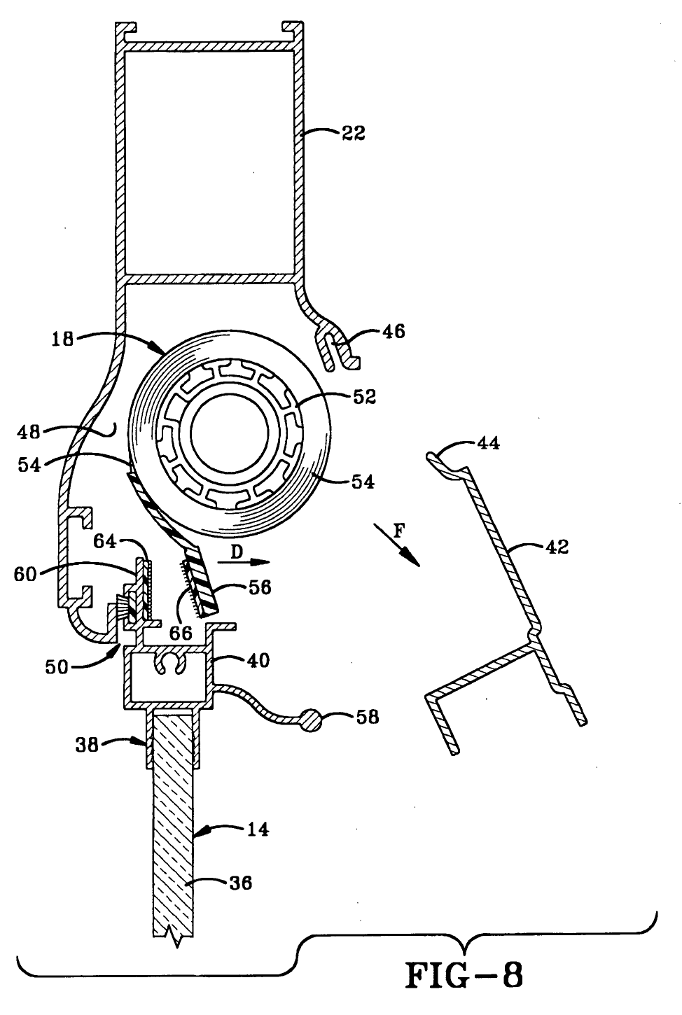

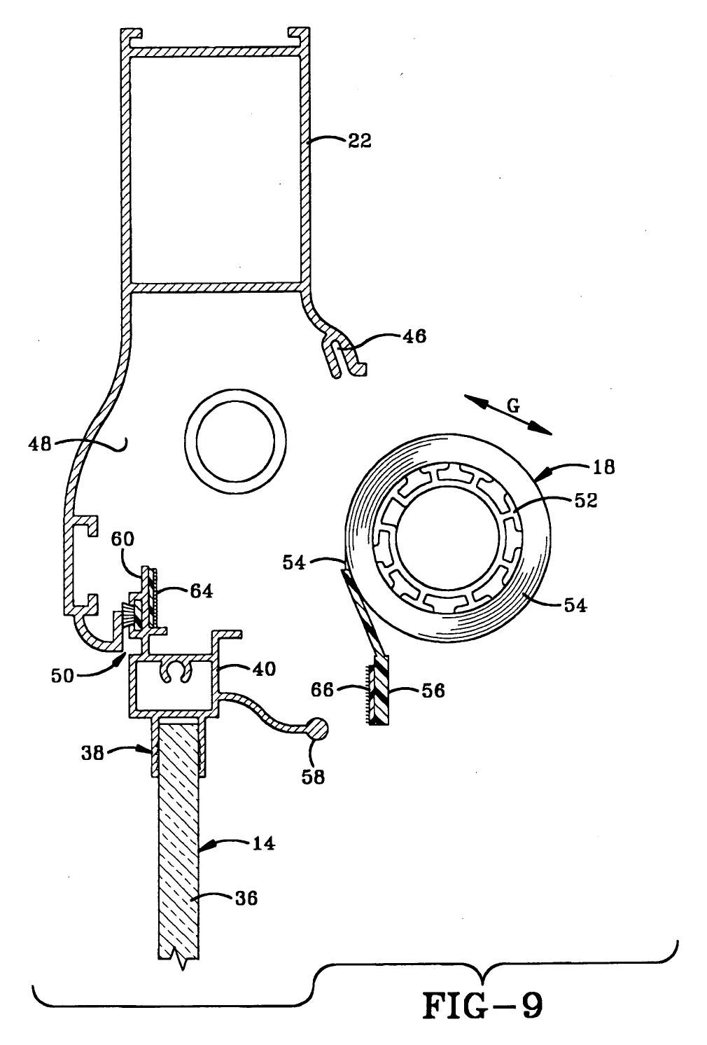

FIG. 6 illustrates the use of mounting mechanism 62 (first embodiment) and thus shows screen 18 in its fully retracted position so that screen 66 is disposed above the channels of channel sections 32 and 34 so that connecting member 66 is peeled away from connecting member 64 as indicated at arrow C. More particularly, a force is applied to member 66 as indicated at arrow D in FIG. 8 which is perpendicular to the plane along which door body 12 and the windows thereof generally lie. It would be far more difficult to remove member 66 from member 64 with application of a strictly vertical force thereto. FIG. 7 shows the alternate removal of screen 54 when using mounting mechanism 72 (second embodiment). More particularly, a vertically upward force is applied as indicated at arrow E in FIG. 7 to peel connecting member 74 from connecting member 72 to disconnect screen 54 from window 14. As illustrated in FIGS. 8 and 9, access cover 42 may be removed from upper section 22 as indicated at arrow F in FIG. 8 so that screen assembly 18 may be removed and replaced as indicated at arrow G in FIG. 9.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A door assembly comprising:
a door body;
a panel slidably mounted on the door body;
a retractable screen mounted on the door body; and
a peelably removable connection between the screen and the panel.

2. The assembly of claim 1 wherein the connection comprises a first magnet.

3. The assembly of claim 2 wherein the connection comprises a second magnet.

4. The assembly of claim 1 wherein the connection comprises a first flexible magnetic strip.

5. The assembly of claim 4 wherein the connection comprises a second flexible magnetic strip.

6. The assembly of claim 1 wherein the connection comprises a self-mating reclosable fastener.

7. The assembly of claim 1 wherein the connection comprises a hook and loop fastener.

8. The assembly of claim 1 wherein the panel is slidable relative to the door body in a first direction; and the connection comprises first and second connecting members removable from one another by a force parallel to the first direction.

9. The assembly of claim 1 wherein the door body is generally flat and lies generally along a plane; and the connection comprises first and second connecting members removable from one another by a force perpendicular to the plane.

10. The assembly of claim 1 wherein the panel comprises a window pane.

11. The assembly of claim 10 further comprising a sash connected to the window pane; and wherein the connection comprises a connecting member on the sash.

12. The assembly of claim 1 further comprising a reinforced strip of material connected to the screen; and wherein the connection comprises a connecting member on the reinforced strip.

13. The assembly of claim 1 further comprising a pair of opposed channels carried by the door body; and wherein the panel is slidably received in each of the channels.

14. The assembly of claim 13 wherein the screen is slidably received within each of the channels.

15. The assembly of claim 1 further comprising a roller which is rotatably mounted on the door body and on which the screen is windingly mounted.

16. The assembly of claim 15 further comprising a retraction mechanism operatively connected to the roller.

17. The assembly of claim 16 wherein the retraction mechanism is spring-loaded.

18. The assembly of claim 15 further comprising an access cover mounted on the door body adjacent the roller.

19. A door assembly comprising:
a door body;
a panel mounted on the door body and slidable relative thereto in a first direction;
a retractable screen mounted on the door body; and
a connection between the screen and panel comprising first and second connecting members removable from one another by a force parallel to the first direction.

20. A door assembly comprising:
a generally flat door body which lies generally along a plane;
a panel slidably mounted on the door body;
a retractable screen mounted on the door body; and
a connection between the screen and panel comprising first and second connecting members removable from one another by a force perpendicular to the plane.
